(19) United States
(12) Patent Application Publication
(10) Pub. No.: US 2026/0103576 A1
(43) Pub. Date: Apr. 16, 2026

(54) TRANSFER FILM AND MANUFACTURING METHOD OF OPTICAL WAVEGUIDE

(71) Applicant: FUJIFILM Corporation, Tokyo (JP)

(72) Inventors: Hideyuki NAKAMURA, Minamiashigara-shi (JP); Wataru HOSHINO, Minamiashigara-shi (JP); Shinji FUJIMOTO, Minamiashigara-shi (JP); Kentaro TOYOOKA, Minamiashigara-shi (JP)

(73) Assignee: FUJIFILM Corporation, Tokyo (JP)

(21) Appl. No.: 19/420,781

(22) Filed: Dec. 16, 2025

Related U.S. Application Data
(63) Continuation of application No. PCT/JP2024/021112, filed on Jun. 11, 2024.

(30) Foreign Application Priority Data
Jul. 20, 2023 (JP) 2023-118377

(51) Int. Cl. C08J 5/18; C08J 7/04; G02F 1/13; G02F 1/1337

(52) U.S. Cl. CPC C08J 5/18; C08J 7/0423; G02F 1/1326; G02F 1/133784

(57) ABSTRACT

An object of the present invention is to provide a transfer film which is used for producing a member for an optical waveguide and which can form an EO layer having a suppressed variation in thickness and exhibiting a high electro-optical constant, and a manufacturing method of an optical waveguide using the transfer film. The transfer film of the present invention is a transfer film for producing a member for an optical waveguide, the transfer film including, in the following order, a temporary support, an alignment layer, and an electro-optical layer containing an organic coloring agent.

### CROSS-REFERENCE TO RELATED APPLICATIONS

This application is a Continuation of PCT International Application No. PCT/JP2024/021112 filed on Jun. 11, 2024, which claims priority under 35 U.S.C. § 119 (a) to Japanese Patent Application No. 2023-118377 filed on Jul. 20, 2023. The above applications are hereby expressly incorporated by reference, in their entirety, into the present application.

### BACKGROUND OF THE INVENTION

### 1. Field of the Invention

The present invention relates to a transfer film for producing a member for an optical waveguide, and a manufacturing method of an optical waveguide.

### 2. Description of the Related Art

In recent years, from the viewpoint of achieving ultra-high-speed optical communication, an organic electro-optical (hereinafter, also abbreviated as “EO”) material has been attracting attention as a material which can be applied to an optical control element (optical element) such as an optical modulator, an optical switch, and an optical interconnect.

For example, JP2022-097407A discloses an electro-optical layer (hereinafter, also abbreviated as “EO layer”) containing a compound represented by Formula (1) (claim 1 and claim 5).

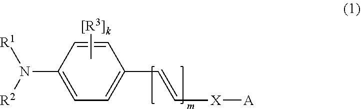

### SUMMARY OF THE INVENTION

As a result of attempting to produce a member for an optical waveguide (for example, a core layer, a clad layer, and the like) using the EO layer disclosed in JP2022-097407A, the present inventors have found that, in a case where the EO layer is formed by coating as disclosed in JP2022-097407A, a variation in thickness occurs in the EO layer, and an electro-optical constant of the EO layer is low.

Therefore, an object of the present invention is to provide a transfer film which is used for producing a member for an optical waveguide and which can form an EO layer having a suppressed variation in thickness and exhibiting a high electro-optical constant, and a manufacturing method of an optical waveguide using the transfer film.

As a result of intensive studies to achieve the above-described object, the present inventors have found that, in a case where a transfer film including a temporary support, an alignment layer, and an electro-optical layer (EO layer) containing an organic coloring agent in this order is used, an EO layer having a suppressed variation in thickness and a high electro-optical constant can be formed, and thus have completed the present invention.

That is, the present inventors have found that the above-described object can be achieved by employing the following configurations.
[1] A transfer film for producing a member for an optical waveguide, the transfer film comprising, in the following order:
   a temporary support;
   an alignment layer; and
   an electro-optical layer containing an organic coloring agent.
[2] The transfer film according to claim 1, further comprising:
   a thermoplastic resin layer between the temporary support and the alignment layer.
[3] The transfer film according to [2],
   in which a melt viscosity of the thermoplastic resin layer at 110° C. is 200 to 3,000 Pa·s.
[4] The transfer film according to any one of [1] to [3],
   in which a melt viscosity of the electro-optical layer at 110° C. is 350 to 180,000 Pa·s.
[5] The transfer film according to any one of [1] to [4],
   in which the alignment layer is a rubbing-treated alignment layer or a photo-alignment layer.
[6] The transfer film according to any one of [1] to [5],
   in which the electro-optical layer contains an organic coloring agent having a second-order molecular susceptibility of 300×10⁻³⁰ esu or more.
[7] The transfer film according to any one of [1] to [6],
   in which an alignment degree of the organic coloring agent contained in the electro-optical layer is 0.25 to 0.95.
[8] The transfer film according to any one of [1] to [7],
   in which the electro-optical layer further contains a liquid crystal compound.
[9] The transfer film according to [8],
   in which an alignment degree of the liquid crystal compound contained in the electro-optical layer is 0.50 to 0.95.
[10] The transfer film according to any one of [1] to [9], further comprising:
   a protective layer on a side of the electro-optical layer opposite to the alignment layer.
[11] The transfer film according to [10],
   in which a surface roughness Ra of the protective layer on a side of the electro-optical layer is 50 nm or less.
[12] The transfer film according to or [11],
   in which the protective layer is a polypropylene film.
[13] The transfer film according to any one of [1] to [12],
   in which the temporary support is a polymer film containing at least one selected from the group consisting of polypropylene, polyethylene, polyethylene terephthalate, polyethylene naphthalate, and triacetyl cellulose.
[14] The transfer film according to [13],
   in which a thickness of the temporary support is 5 to 200 μm.
[15] The transfer film according to [2] or [3],
   in which a thickness of the thermoplastic resin layer is 2 to 20 μm.
[16] A manufacturing method of an optical waveguide, comprising:
   a step of adhering the electro-optical layer included in the transfer film according to any one of [1] to [15] to an adherend to form an optical waveguide.

According to the present invention, it is possible to provide a transfer film which is used for producing a member for an optical waveguide and which can form an EO layer having a suppressed variation in thickness and exhibiting a high electro-optical constant, and a manufacturing method of an optical waveguide using the transfer film.

### BRIEF DESCRIPTION OF THE DRAWINGS

FIG. 1 is a schematic cross-sectional view showing an example of a layer configuration of the transfer film according to the embodiment of the present invention.

FIG. 2 is a schematic cross-sectional view showing another example of a layer configuration of the transfer film according to the embodiment of the present invention.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

Any numerical range expressed using “to” in the present specification refers to a range including the numerical values before and after the “to” as a lower limit value and an upper limit value, respectively.

In addition, in a range of numerical values described in stages in the present specification, the upper limit value or the lower limit value described in a certain range of numerical values may be replaced with an upper limit value or a lower limit value of the range of numerical values described in other stages. In addition, regarding the numerical range described in the present specification, an upper limit value or a lower limit value described in a numerical value may be replaced with a value described in Examples.

In addition, in the present specification, substances corresponding to respective components may be used alone or in combination of two or more kinds thereof. Here, in a case where two or more kinds of substances are used in combination for each component, the content of the component indicates the total content of the substances used in combination, unless otherwise specified.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

### [Transfer Film]

The transfer film according to the embodiment of the present invention is a transfer film for producing a member for an optical waveguide, the transfer film including, in the following order, a temporary support, an alignment layer, and an electro-optical layer (EO layer) containing an organic coloring agent.

In addition, from the viewpoint of suppressing entrainment of air bubbles in a case of forming the EO layer, it is preferable that the transfer film according to the embodiment of the present invention further includes a thermoplastic resin layer between the temporary support and the alignment layer.

Similarly, from the viewpoint of suppressing the entrainment of air bubbles in a case of forming the EO layer, it is preferable that the transfer film according to the embodiment of the present invention further includes a protective layer on a side of the electro-optical layer opposite to the alignment layer.

In the present invention, as described above, in a case where a transfer film including a temporary support, an alignment layer, and an electro-optical layer (EO layer) containing an organic coloring agent in this order is used, an EO layer having a suppressed variation in thickness and a high electro-optical constant can be formed.

The reason why the effect is exhibited is not clear in detail, but the present inventors have presumed as follows.

That is, in the present invention, by using the transfer film, it is possible to provide the electro-optical layer containing an organic coloring agent on the base circuit or the like without reducing or without causing the contact with a solvent, so that the variation in thickness of the EO layer can be suppressed, and thus the electro-optical constant is also increased.

Next, a layer configuration of the transfer film according to the embodiment of the present invention will be described with reference to the drawings.

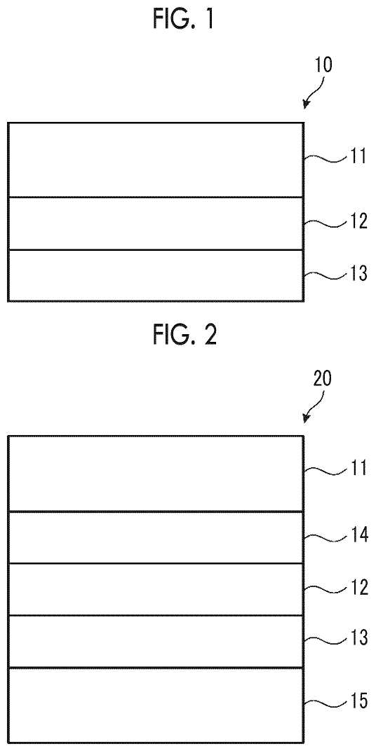

A transfer film 10 shown in FIG. 1 includes a temporary support 11, an alignment layer 12, and an electro-optical layer 13 containing an organic coloring agent in this order.

In addition, a transfer film 20 shown in FIG. 2 further includes a thermoplastic resin layer 14 between the temporary support 11 and the alignment layer 12, and further includes a protective layer 15 on a side of the electro-optical layer 13 opposite to the alignment layer 12.

Hereinafter, each member of the transfer film according to the embodiment of the present invention will be described in detail.

### [Temporary Support]

The temporary support included in the transfer film according to the embodiment of the present invention is a member which supports the alignment layer or the electro-optical layer described later, and is a member which is removed after production of a member for an optical waveguide.

The temporary support may have a monolayer structure or a multilayer structure.

As the temporary support, a film is preferable, and a polymer film is more preferable.

In addition, as the temporary support, a polymer film having flexibility and not having significant deformation, contraction, or elongation under pressure or under pressure and heating is also preferable; and a polymer film having no deformation such as wrinkles and no scratches is also preferable.

Examples of such a polymer film include a polymer film containing at least one selected from the group consisting of polypropylene (PP), polyethylene (PE), polyethylene terephthalate (PET), polyethylene naphthalate (PEN), and triacetyl cellulose (TAC); and a polyethylene terephthalate film is preferable.

A thickness of the temporary support is not particularly limited, but from the viewpoint of handleability and general-purpose properties, it is preferably 5 to 200 μm, more preferably 5 to 150 μm, and still more preferably 5 to 100 μm.

Here, the thickness of the temporary support is calculated as an average value in a case where an area of 10 cm×10 cm is measured at 100 points at an interval of 1 cm using a digital measuring device PHA-13W of TOSEI ENGINEERING CORP. with an E-ST-100 DB stand attached thereto and using MINICOM-M (Model E-M) as a display device.

### [Alignment Layer]

The alignment layer included in the transfer film according to the embodiment of the present invention may be any layer as long as the organic coloring agent contained in the electro-optical layer described later can be brought into a desired alignment state.

Examples of a method for forming the alignment layer include methods such as rubbing treatment of a film surface of an organic compound (preferably a polymer), oblique vapor deposition of an inorganic compound, formation of a layer having microgrooves, and accumulation of an organic compound (for example, @-tricosanoic acid, dioctadecylmethylammonium chloride, or methyl stearate) by the Langmuir-Blodgett method (LB film). Furthermore, an alignment layer in which an alignment function is generated by application of an electric field, application of a magnetic field, or light irradiation has been also known.

In addition, the alignment layer may be formed by coating of the electro-optical layer described later in one step. For example, an aspect in which a composition containing an organic coloring agent and an alignment agent is applied to the temporary support, and the alignment agent is spontaneously dispersed on the temporary support side before or during volatilization of a solvent of the coating liquid to form an alignment layer may be adopted. In this aspect, a site where an alignment agent component constituting a film per 1 g is 50% by mass or more after the solvent is volatilized is regarded as the alignment layer to be formed.

A thickness of the alignment layer is not particularly limited, but is preferably 0.01 to 2.0 μm and more preferably 0.01 to 1.0 μm.

Here, the thickness of the alignment layer is calculated as an average value of any five points measured using a surface roughness meter (for example, P-10 (manufactured by TENCOR)).

In the present invention, from the viewpoint of ease of controlling a pretilt angle of the alignment layer, an alignment layer formed by a rubbing treatment (rubbing-treated alignment layer) is preferable; and from the viewpoint of uniformity of alignment, a photo-alignment layer formed by light irradiation is preferable.

### <Rubbing-Treated Alignment Layer>

A polymer material used for the alignment layer formed by a rubbing treatment is described in a plurality of documents, and a plurality of commercially available products can be used. In the present invention, polyvinyl alcohol or polyimide, or derivatives thereof are preferably used. The alignment layer can refer to the description on page 43, line 24 to page 49, line 8 of WO2001/88574A1.

### <Photo-Alignment Layer>

A photo-alignment compound used for the alignment layer formed by irradiation with light is described in a plurality of documents. In the present invention, preferred examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadimide compounds having a photo-alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. Azo compounds, photo-crosslinkable polyimides, polyamides, or esters are more preferable.

Among these, a photosensitive compound having a photo-aligned group, which undergoes at least one of dimerization or isomerization by action of light is preferably used as the photo-alignment compound.

In addition, examples of the photo-aligned group include a group having a cinnamic acid (cinnamoyl) structure (skeleton), a group having a coumarin structure (skeleton), a group having a chalcone structure (skeleton), a group having a benzophenone structure (skeleton), and a group having an anthracene structure (skeleton). Among these groups, a group having a cinnamoyl structure or a group having a coumarin structure is preferable, and a group having a cinnamoyl structure is more preferable.

In addition, the photosensitive compound having the above-described photo-aligned group may further have a crosslinkable group.

As the above-described crosslinkable group, a thermally crosslinking group which causes a curing reaction due to action of heat or a photo-crosslinkable group which causes a curing reaction due to action of light is preferable, and the crosslinkable group may be a crosslinkable group which has both the thermally crosslinking group and the photo-crosslinkable group.

Examples of the above-described crosslinkable group include at least one selected from the group consisting of an epoxy group, an oxetanyl group, a group represented by —NH—CH₂—O-R (R represents a hydrogen atom or an alkyl group having 1 to 20 carbon atoms), a group having an ethylenically unsaturated double bond, and a blocked isocyanate group. Among these, an epoxy group, an oxetanyl group, or a group having an ethylenically unsaturated double bond is preferable.

A 3-membered cyclic ether group is also referred to as the epoxy group, and a 4-membered cyclic ether group is also referred to as the oxetanyl group.

In addition, specific examples of the group having an ethylenically unsaturated double bond include a vinyl group, an allyl group, a styryl group, an acryloyl group, and a methacryloyl group, and an acryloyl group or a methacryloyl group is preferable.

The photo-alignment layer is produced by subjecting the photo-alignment layer formed of the above-described material to irradiation with linearly polarized light or non-polarized light.

In the present specification, the “irradiation with linearly polarized light” and the “irradiation with non-polarized light” are operations for causing a photo-reaction in the photo-alignment material. A wavelength of the light to be used varies depending on the photo-alignment material to be used, and is not particularly limited as long as the wavelength is required for the photo-reaction. A peak wavelength of the light to be used for irradiation with light is preferably 200 nm to 700 nm, and ultraviolet light having a peak wavelength of 400 nm or less is more preferable.

Examples of a light source used for the light irradiation include commonly used light sources, for example, lamps such as a tungsten lamp, a halogen lamp, a xenon lamp, a xenon flash lamp, a mercury lamp, a mercury xenon lamp, or a carbon arc lamp, various lasers [such as a semiconductor laser, a helium neon laser, an argon ion laser, a helium cadmium laser, and a yttrium aluminum garnet (YAG) laser], a light emitting diode, and a cathode ray tube.

As a method of obtaining the linearly polarized light, a method of using a polarizing plate (for example, iodine polarizing plate, dichroic coloring agent polarizing plate, and wire grid polarizing plate), a method of using a prismatic element (for example, Glan-Thompson prism) or a reflective type polarizer using Brewster's angle, or a method of using light emitted from a polarized laser light source can be adopted. In addition, by using a filter, a wavelength conversion element, or the like, only light having a required wavelength may be radiated selectively.

In a case where light to be applied is the linearly polarized light, a method of applying light vertically or obliquely to the upper surface of the alignment layer or the surface of the alignment layer from the rear surface is employed. An incidence angle of light varies depending on the photo-alignment material, but is preferably 0° to 90° (vertical) and preferably 40° to 90°.

In a case where the light to be applied is the non-polarized light, the alignment layer is irradiated with the non-polarized light obliquely. An incidence angle is preferably 10° to 80°, more preferably 20° to 60°, and particularly preferably 30° to 50°.

The irradiation time is preferably 1 minute to 60 minutes and more preferably 1 minute to 10 minutes.

In a case where patterning is required, a method of performing irradiation with light using a photo mask as many times as necessary for pattern preparation or a method of writing a pattern by laser light scanning can be employed.

### [Electro-Optical Layer (EO Layer)]

The electro-optical layer (EO layer) included in the transfer film according to the embodiment of the present invention is an organic layer containing an organic coloring agent.

In addition, the electro-optical layer included in the transfer film according to the embodiment of the present invention may be subjected to or not subjected to a poling treatment.

Therefore, in a case where the electro-optical layer included in the transfer film according to the embodiment of the present invention is not subjected to the poling treatment, the poling treatment may be performed after transfer of the electro-optical layer, that is, in a stage of producing the member for an optical waveguide.

Here, the poling treatment is not particularly limited, and known poling treatments such as a light poling method and an electric field poling method can be adopted. Among these, the electric field poling method is particularly preferable from the viewpoint of simplicity of a device, an alignment degree to be obtained, and the like.

The above-described electric field poling method is roughly classified into a contact poling method of sandwiching a nonlinear optical material between a pair of electrodes and applying an electric field, and a corona poling method of performing corona discharge on a surface of a nonlinear optical material on a substrate electrode and applying a charging electric field.

### <Organic Coloring Agent>

The organic coloring agent contained in the electro-optical layer is not particularly limited, and a known organic EO material in the related art can be used.

From the viewpoint of being able to form an EO layer having a higher electro-optical constant and being able to suppress alignment relaxation over time, a concentration of the organic coloring agent is preferably 5% to 60% by mass and more preferably 10% to 50% by mass with respect to the mass of the EO layer.

In the present invention, from the viewpoint of reducing power consumption (reducing driving voltage) and reducing the size of the EO element, the electro-optical layer preferably contains an organic coloring agent having a second-order molecular susceptibility of 300×10⁻³⁰ esu or more, and more preferably contains an organic coloring agent having a second-order molecular susceptibility of 500×10⁻³⁰ esu or more and 10000×10⁻³⁰ esu or less.

Here, the second-order molecular susceptibility of the organic coloring agent refers to a value calculated by a density functional theory under the following conditions using Gaussian 16.
Functional: M06×02
Basic function: 6-31+g(d,p)
Solvent effect: chloroform

Other conditions: default value of Gaussian 16

In the present invention, from the viewpoint of reducing the power consumption, an alignment degree of the organic coloring agent contained in the electro-optical layer is preferably 0.25 or more, more preferably 0.40 or more, and still more preferably 0.50 or more.

In addition, there is a method of increasing the alignment degree to 0.95 or more by crystallization of the coloring agent, but light scattering of fine particles occurs due to crystallization of the coloring agent, which reduces a light transmission efficiency in the fiber, so that the alignment degree of the organic coloring agent contained in the electro-optical layer is preferably 0.99 or less, more preferably 0.98 or less, and still more preferably 0.95 or less. In a case where the coloring agent is not crystallized, the upper limit of the alignment degree is not limited, but is usually 0.99 or less.

Here, the alignment degree of the organic coloring agent refers to a value calculated by the following procedure.

In a state in which a linear polarizer is inserted on a light source side of an optical microscope (for example, a product “ECLIPSE E600 POL” manufactured by Nikon Corporation), a laminate having the electro-optical layer is set on a sample stage, an absorbance of the electro-optical layer in a wavelength range of 380 nm to 780 nm is measured at a pitch of 1 nm using a multi-channel spectrometer (Ocean Optics, Inc., product name “QE65000”), and an alignment degree in a wavelength range of 400 nm to 700 nm is calculated by the following expression.

$$Alignment degree : S = ( ( Az 0 / Ay 0 ) - 1 ) / ( ( Az 0 / Ay 0 ) + 2 )$$

In the above-described expression, “Az0” represents an absorbance of the electro-optical layer with respect to polarization in an absorption axis direction, and “Ay0” represents an absorbance of the electro-optical layer with respect to polarization in a transmission axis direction.

In the present invention, from the viewpoint of level difference followability and prevention of air bubble entrapment, a melt viscosity of the electro-optical layer at 110° C. is preferably 350 to 180,000 Pa's and more preferably 3,000 to 30,000 Pa·s.

Here, the melt viscosity of the electro-optical layer at 110° C. refers to a value measured at a temperature of 110° C. and a frequency of 1 Hz using a viscoelasticity measuring device (for example, DynAlyser DAS-100 manufactured by International Co., Ltd.).

### <Liquid Crystal Compound>

In the present invention, from the viewpoint of being able to increase the above-described alignment degree of the organic coloring agent, it is preferable that the electro-optical layer further contains a liquid crystal compound.

As the liquid crystal compound, both a high-molecular-weight liquid crystal compound and a low-molecular-weight liquid crystal compound can be used, and from the viewpoint of increasing the alignment degree, a high-molecular-weight liquid crystal compound is preferable. In addition, the high-molecular-weight liquid crystal compound and the low-molecular-weight liquid crystal compound may be used in combination as the liquid crystal compound.

Here, the “high-molecular-weight liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the high-molecular-weight liquid crystal compound include thermotropic liquid crystalline polymers described in JP2011-237513A and high-molecular-weight liquid crystal compounds described in paragraphs to of WO2018/199096A.

Examples of the low-molecular-weight liquid crystal compound include liquid crystal compounds described in paragraphs to of JP2013-228706A, and among these, a liquid crystal compound exhibiting smectic properties is preferable.

Examples of such a liquid crystal compound include compounds described in paragraphs to of WO2022/014340A, the description of which is incorporated herein by reference.

In particular, suitable examples of the high-molecular-weight liquid crystal compound include a liquid crystal compound having a repeating unit represented by Formula (1), described in paragraph of WO2018/199096A.

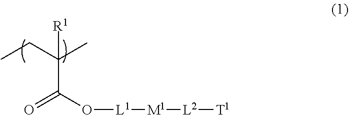

In Formula (1), R¹ represents a hydrogen atom or a methyl group, L¹ and L² each independently represent a single bond or a divalent linking group, M¹ represents a mesogenic group represented by Formula (1-1) described later, and T¹ represents a terminal group.

In addition, suitable examples of the low-molecular-weight liquid crystal compound include a compound represented by Formula (2), described in paragraph of JP2013-228706A.

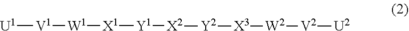

[in Formula (2),
X¹, X², and X³ each independently represent a 1,4-phenylene group which may have a substituent or a cyclohexane-1,4-diyl group which may have a substituent,
at least one of X¹, X², or X³ represent a 1,4-phenylene group which may have a substituent, —CH₂— constituting the cyclohexane-1,4-diyl group which may have a substituent may be replaced with —O—, —S—, or -NR-, R represents an alkyl group having 1 to 6 carbon atoms or a phenyl group,
Y¹ and Y² each independently represent —CH₂CH₂—, —CH₂O—, —COO—, —OCOO—, a single bond, —N═N—, —CR^{a}═CR^{b}—, —C═C—, or —CR^{a}═N—, R^{a} and R^{b} each independently represent a hydrogen atom or an alkyl group having 1 to 4 carbon atoms,
U¹ represents a hydrogen atom or a polymerizable group,
U² represents a polymerizable group,
W¹ and W² each independently represent a single bond, —O—, —S—, —COO—, or —OCOO—, and
V¹ and V² each independently represent an alkanediyl group having 1 to 20 carbon atoms, which may have a substituent, where —CH₂-constituting the alkanediyl group may be replaced with —O—, —S—, or —NH—]

In a case where the electro-optical layer contains a liquid crystal compound, a content of the liquid crystal compound is preferably 40 to 95 parts by mass and more preferably 50 to 90 parts by mass with respect to 100 parts by mass of the above-described organic coloring agent.

In a case where the electro-optical layer contains a liquid crystal compound, a content of the liquid crystal compound is preferably 40 to 95 parts by mass and more preferably 50 to 90 parts by mass with respect to 100 parts by mass of the total content of the above-described organic coloring agent and the liquid crystal compound.

In the present invention, from the viewpoint of increasing the alignment degree of the organic coloring agent, an alignment degree of any liquid crystal compound contained in the electro-optical layer is preferably 0.50 to 0.95 and more preferably 0.7 to 0.95.

Here, the alignment degree of the liquid crystal compound refers to a vertical alignment degree calculated by the following procedure.

First, polarization-attenuated total reflectance (ATR)-infrared spectroscopy (IR) measurement (ATR crystal: Ge, incidence angle: 45 degrees) is performed on a measurement target (the electro-optical layer containing the organic coloring agent and the liquid crystal compound) using a Fourier transform infrared spectrophotometer (for example, VERTEX70 manufactured by Bruker Corporation) with respect to an incidence polarization (P/S), and a three-dimensional light absorption coefficient is determined.

Next, using the following expression, an alignment degree P_{2Z} in a z-axis direction is calculated as the alignment degree of the liquid crystal compound from the determined three-dimensional light absorption coefficient.

It is assumed that the liquid crystal compound is isotropic and has a refractive index of 1.5, and is uniaxially aligned in the z-axis direction.

$${P}_{2 Z} = ( {k}_{z} / {k}_{x} - 1 ) / ( {k}_{z} / {k}_{x} + 2 )$$

$${k}_{x} = {k}_{y} = 1.5$$

A thickness of the electro-optical layer is not particularly limited, but is preferably 0.3 to 5.0 μm and more preferably 1.0 to 3.0 μm in consideration of connection with an optical fiber.

Here, the thickness of the electro-optical layer is calculated as an average value of any five points measured using a surface roughness meter (for example, P-10 (manufactured by TENCOR)).

### <Method of Forming Electro-Optical Layer>

A method of forming the electro-optical layer is not particularly limited, and examples thereof include a method including a step of applying a composition containing the above-described organic coloring agent and liquid crystal compound (hereinafter, also abbreviated as “EO composition”) to the above-described alignment layer to form a coating film (hereinafter, also referred to as “coating film forming step”) and a step of aligning the organic coloring agent and the liquid crystal compound contained in the coating film (hereinafter, also referred to as “alignment step”) in this order.

### (Vertical Alignment Agent)

The EO composition preferably contains a vertical alignment agent.

Here, the vertical alignment agent refers to an additive having a function of aligning the above-described liquid crystal compound in a direction perpendicular to a principal plane of the electro-optical layer. The term “aligning in a direction perpendicular to” does not require the alignment at exactly 90°, but means the alignment at 70° to 110°.

Examples of the vertical alignment agent include an ionic vertical alignment agent and a vertical alignment agent having a boronic acid group; and it is preferable to use an ionic vertical alignment agent and a vertical alignment agent having a boronic acid group in combination.

Examples of the vertical alignment agent include compounds described in paragraphs to of JP2023-4859A, the description of which is incorporated herein by reference.

### (Solvent)

From the viewpoint of workability and the like, it is preferable that the EO composition contains a solvent.

Examples of the solvent include organic solvents such as ketones (such as acetone, 2-butanone, methyl isobutyl ketone, cyclopentanone, cyclohexanone, and acetylacetone), ethers (such as dioxane, tetrahydrofuran, tetrahydropyran, dioxolane, tetrahydrofurfuryl alcohol, cyclopentyl methyl ether, and dibutyl ether), aliphatic hydrocarbons (such as hexane), alicyclic hydrocarbons (such as cyclohexane), aromatic hydrocarbons (such as benzene, toluene, xylene, tetralin, and trimethylbenzene), halogenated carbons (such as dichloromethane, trichloromethane (chloroform), dichloroethane, dichlorobenzene, 1,1,2,2-tetrachloroethane, and chlorotoluene), esters (such as methyl acetate, ethyl acetate, butyl acetate, diethyl carbonate, ethyl acetoacetate, n-pentyl acetate, ethyl benzoate, benzyl benzoate, butyl carbitol acetate, diethylene glycol monoethyl ether acetate, and isoamyl acetate), alcohols (such as ethanol, isopropanol, butanol, cyclohexanol, furfuryl alcohol, 2-ethylhexanol, octanol, benzyl alcohol, ethanolamine, ethylene glycol, propylene glycol, diethylene glycol, diethylene glycol monomethyl ether, diethylene glycol monoethyl ether, and diethylene glycol monobutyl ether), phenols (such as phenol and cresol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, and 1,3-dimethyl-2-imidazolidinone), and heterocyclic compounds (such as pyridine and 2,6-lutidine); and water.

These solvents may be used alone or in combination of two or more kinds thereof.

### (Polymerization Initiator)

The EO composition may contain a polymerization initiator.

The polymerization initiator is not particularly limited, but a compound having photosensitivity, that is, a photopolymerization initiator is preferable.

As the photopolymerization initiator, various compounds can be used without any particular limitation. Examples of the photopolymerization initiator include α-carbonyl compounds (U.S. Pat. Nos. 2,367,661A, 2,367,670A), acyloin ether (U.S. Pat. No. 2,448,828A), α-hydrocarbon-substituted aromatic acyloin compounds (U.S. Pat. No. 2,722,512A), polynuclear quinone compounds (U.S. Pat. Nos. 3,046,127A, 2,951,758A), a combination of a triarylimidazole dimer and a p-aminophenyl ketone (U.S. Pat. No. 3,549,367A), acridine and phenazine compounds (JP1985-105667A (JP-S60-105667A) and U.S. Pat. No. 4,239,850A), oxadiazole compounds (U.S. Pat. No. 4,212,970A), o-acyloxime compounds ([0065] of JP2016-27384A), and acylphosphine oxide compounds (JP1988-40799B (JP-S63-40799B), JP1993-29234B (JP-H5-29234B), JP1998-95788A (JP-H10-95788A), and JP1998-29997A (JP-H10-29997A)).

Commercially available products can also be used as such a photopolymerization initiator, and examples thereof include IRGACURE-184, IRGACURE-907, IRGACURE-369, IRGACURE-651, IRGACURE-819, IRGACURE-OXE-01, and IRGACURE-OXE-02, manufactured by BASF SE.

### (Interface Improver)

The EO composition may contain an interface improver.

The interface improver is not particularly limited, and a polymer-based interface improver or a low-molecular-weight interface improver can be used, and compounds described in paragraphs [0253] to [0293] of JP2011-237513A can also be used.

In addition, fluorine (meth)acrylate-based polymers described in to of JP2007-272185A can also be used as the interface improver.

In addition, examples of the interface improver include compound described in paragraphs [0079] to [0102] of JP2007-069471A, polymerizable liquid crystal compounds represented by Formula (4) described in JP2013-047204A (particularly, compounds described in paragraphs [0020] to [0032]), polymerizable liquid crystal compounds represented by Formula (4) described in JP2012-211306A (particularly, compounds described in paragraphs [0022] to [0029]), liquid crystal alignment promoters represented by Formula (4) described in JP2002-129162A (particularly, compounds described in paragraphs [0076] to [0078] and paragraphs [0082] to [0084]), compounds represented by Formulae (4), (II), and (III) described in JP2005-099248A (particularly, compounds described in paragraphs [0092] to [0096]), compounds described in paragraphs to of JP4385997B, compounds described in paragraphs [0018] to [0044] of JP5034200B, and compounds described in paragraphs [0019] to [0038] of JP4895088B.

The interface improvers may be used alone or in combination of two or more kinds thereof.

### (Coating Film Forming Step)

The coating film forming step is a step of applying the EO composition to form a coating film.

The photo-alignment layer is easily coated with the EO composition by using an EO composition containing the above-described solvent or using a liquid-like material such as a melt, which is obtained by heating the EO composition.

Specific examples of a method of applying the EO composition include known methods such as a roll coating method, a gravure printing method, a spin coating method, a wire bar coating method, an extrusion coating method, a direct gravure coating method, a reverse gravure coating method, a die-coating method, a spraying method, and an inkjet method.

### (Alignment Step)

The alignment step is a step of aligning the organic coloring agent and the liquid crystal compound contained in the coating film. As a result, the electro-optical layer is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the organic coloring agent and the liquid crystal compound contained in the EO composition may be aligned by the above-described coating film forming step or the drying treatment. For example, in an aspect in which the EO composition is prepared as a coating liquid containing a solvent, the EO layer is obtained by drying the coating film to remove the solvent from the coating film.

It is preferable that the alignment step includes a heat treatment. As a result, the organic coloring agent and the liquid crystal compound contained in the coating film can be aligned, so that the coating film after the heating treatment can be suitably used as the EO layer.

From the viewpoint of manufacturing suitability or the like, the heat treatment is performed at a temperature of preferably 10° C. to 250° C. and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). As a result, the alignment of the organic coloring agent and the liquid crystal compound included in the coating film can be fixed. A cooling unit is not particularly limited, and the cooling treatment can be performed according to a known method.

### (Other Steps)

The method of forming the electro-optical layer may include a step of curing the electro-optical layer (hereinafter, also referred to as “curing step”) after the above-described alignment step. The curing step is performed by, for example, heating and/or performing light irradiation (exposure) in a case where the component contained in the electro-optical layer (or the EO composition) has a crosslinkable group (polymerizable group). Among these, it is preferable that the curing step is performed by irradiating the light absorption anisotropic layer with light.

In addition, the method of forming the electro-optical layer may include a step of performing the above-described poling treatment after the above-described alignment step (or the above-described curing step).

### [Thermoplastic Resin Layer]

As described above, from the viewpoint of suppressing entrainment of air bubbles in a case of forming the EO layer, it is preferable that the transfer film according to the embodiment of the present invention further includes a thermoplastic resin layer between the temporary support and the alignment layer.

Here, the thermoplastic resin layer has a function as a cushion material which can absorb unevenness of a base surface (including unevenness or the like due to an image already formed) on which the electro-optical layer is to be transferred, and preferably has a property of being deformable according to the unevenness.

In the present invention, the thermoplastic resin layer is preferably alkali-soluble.

In addition, the thermoplastic resin layer preferably has an aspect in which an organic polymer substance described in JP1993-72724A (JP-H5-72724A) is contained as a component; and particularly preferably has an aspect in which at least one selected from organic polymer substances having a softening point of approximately 80° C. or lower by a Vicat method [specifically, a polymer softening point measuring method according to ASTM D1235] is contained.

Specific examples of the organic polymer substance include organic polymers including polyolefin such as polyethylene and polypropylene; an ethylene copolymer of ethylene and vinyl acetate or a saponified material thereof; a copolymer of ethylene and an acrylic acid ester or a saponified material thereof; polyvinyl chloride or a vinyl chloride copolymer of vinyl chloride and vinyl acetate or a saponified material thereof; polyvinylidene chloride, a vinylidene chloride copolymer, polystyrene, or a styrene copolymer of styrene and a (meth)acrylic acid ester or a saponified material thereof; polyvinyltoluene or a vinyltoluene copolymer of vinyltoluene and a (meth)acrylic acid ester or a saponified material thereof; poly(meth)acrylic acid ester or a (meth)acrylic acid ester copolymer of (meth)acrylic acid butyl and vinyl acetate or the like; a polyamide resin such as vinyl acetate-copolymerized nylon, copolymer nylon, N-alkoxymethylated nylon, and N-dimethylamino-modified nylon; and the like.

A thickness of the thermoplastic resin layer is not particularly limited, but from the viewpoint of sufficient followability to the unevenness of the base surface and reduction of a load related to drying in a case of forming the thermoplastic resin layer, it is preferably 2 to 20 μm and more preferably 2 to 14 μm.

Here, the thickness of the thermoplastic resin layer is calculated as an average value of any five points measured using a surface roughness meter (for example, P-10 (manufactured by TENCOR)).

The thermoplastic resin layer can be formed by applying a preparation liquid containing the organic polymer substance, and the preparation liquid used in the application or the like can be prepared using a solvent.

The solvent is not particularly limited as long as it can dissolve the organic polymer substance; and examples thereof include methyl ethyl ketone, cyclohexanone, propylene glycol monomethyl ether acetate, n-propanol, and 2-propanol.

In the present invention, from the viewpoint of improving workability during transfer and achieving sufficient followability to the unevenness of the base surface, a melt viscosity n of the thermoplastic resin layer at 110° C. is preferably 200 to 3,000 Pas, more preferably 300 to 2,500 Pa's, and still more preferably 500 to 2,000 Pa·s.

Here, the melt viscosity of the thermoplastic resin layer at 110° C. refers to a value measured at a temperature of 110° C. and a frequency of 1 Hz using a viscoelasticity measuring device (for example, DynAlyser DAS-100 manufactured by International Co., Ltd.).

As a method of adjusting the melt viscosity n of the thermoplastic resin layer within the above-described range, there is a method of adjusting a content of a low-molecular-weight polymer and a content of a plasticizer in a binder (for example, the above-described organic polymer substance) contained in the thermoplastic resin layer.

A content ratio of a high-molecular-weight polymer and a low-molecular-weight polymer in the polymer constituting the thermoplastic resin layer is preferably 10/90 or more and less than 45/55, more preferably 12/88 or more and less than 40/60, and most preferably 15/85 or more and less than 38/62.

Here, the low-molecular-weight polymer refers to a polymer having a weight-average molecular weight of 3,000 or more and less than 10,000.

A content of the plasticizer is preferably 28% to 43% by mass, more preferably 30% to 40% by mass, and still more preferably 32% to 38% by mass with respect to the mass of solid contents of the binder and the plasticizer contained in the thermoplastic resin layer.

### [Protective Layer]

As described above, from the viewpoint of suppressing the entrainment of air bubbles in a case of forming the EO layer, it is preferable that the transfer film according to the embodiment of the present invention further includes a protective layer having high smoothness, on a side of the electro-optical layer opposite to the alignment layer.

As the protective layer, it is preferable to use a material having flexibility and not having significant deformation, contraction, or elongation under pressure or under pressure and heating.

As such a protective layer, for example, a cover film described in paragraphs [0083] to [0087] and [0093] of JP2006-259138A can be appropriately used, and specific examples thereof include a polyolefin film such as a polyethylene film and a polypropylene film; a polyester film such as a polyethylene terephthalate film; a cellulose triacetate film; a polystyrene film; and a polycarbonate film, where a polyolefin film is preferable and a polypropylene film is more preferable.

A thickness of the protective layer is not particularly limited, but from the viewpoint of handleability, general-purpose properties, and the like, it is preferably 1 to 50 μm, more preferably 3 to 30 μm, and still more preferably 5 to 20 μm.

Here, in the same manner as in the temporary support described above, the thickness of the protective layer is calculated as an average value in a case where an area of 10 cm×10 cm is measured at 100 points at an interval of 1 cm using a digital measuring device PHA-13W of TOSEI ENGINEERING CORP. with an E-ST-100 DB stand attached thereto and using MINICOM-M (Model E-M) as a display device.

In the present invention, from the viewpoint of further suppressing the entrainment of air bubbles in a case of forming the EO layer, a surface roughness Ra of the protective layer on the electro-optical layer side is preferably 50 nm or less and more preferably 25 nm or less. The lower limit value of the surface roughness Ra is not particularly limited, but is preferably 1 nm or more from the viewpoint of manufacturing.

Here, the surface roughness Ra refers to a value measured by the following method.

First, a surface profile of the protective layer on the electro-optical layer side is obtained under the following conditions using a three-dimensional optical profiler (New View 7300, manufactured by Zygo Corporation). As a measurement and analysis software, Microscope Application of MetroPro ver. 8.3.2 is used.

Next, a Surface Map screen is displayed by the above-described analysis software (MetroPro ver8.3.2-Microscope Application), and histogram data is obtained on the Surface Map screen.

Next, an arithmetic average roughness is calculated from the obtained histogram data, and is defined as the surface roughness R^{a}.

In a case where the protective layer and the EO layer are in contact with each other, the surface roughness R^{a} is measured using a peeling surface exposed by peeling off the protective layer as the measurement surface.

### (Measurement Conditions)

Objective lens: 50 times
Zoom: 0.5×
Measurement region: 1.00 mm×1.00 mm
(Analytical conditions)
Removed: plane
Filter: off
Filter Type: average
Remove spikes: on
Spike Height (xRMS): 7.5

### [Manufacturing Method of Optical Waveguide]

The manufacturing method of an optical waveguide according to the embodiment of the present invention includes a step of adhering the electro-optical layer included in the above-described transfer film according to the embodiment of the present invention to an adherend to form an optical waveguide.

Here, an adhering method to the adherend is not particularly limited, and examples thereof include a method of adhering the electro-optical layer to a member for an optical waveguide, such as a core layer and a clad layer, through a known adhesive.

In a case where the above-described transfer film according to the embodiment of the present invention has the protective layer, it is preferable to adhere the electro-optical layer to the adherend after peeling off the protective layer.

In addition, examples of a manufacturing method according to a first aspect of the manufacturing method of an optical waveguide according to the embodiment of the present invention include a method of manufacturing a hybrid waveguide-type optical waveguide by adhering the electro-optical layer included in the above-described transfer film according to the embodiment of the present invention as a clad layer to a surface of a substrate having a patterned core layer (for example, a Si layer) on a core layer side, and then peeling off the temporary support.

The poling treatment to be performed on the electro-optical layer may be performed at any timing before or after the adhering of the electro-optical layer as described above.

In addition, examples of a manufacturing method according to a second aspect of the manufacturing method of an optical waveguide according to the embodiment of the present invention include a method of manufacturing a polymer waveguide-type optical waveguide by adhering the electro-optical layer included in the above-described transfer film according to the embodiment of the present invention to a surface of a substrate having a clad layer, on a clad layer side, peeling off the temporary support, and then performing patterning (for example, dry etching using a resist) on the electro-optical layer to form a core layer.

### EXAMPLES

Hereinafter, the present invention will be described in more detail with reference to Examples. The materials, the amounts of materials to be used, the proportions, the treatment details, the treatment procedure, or the like shown in the examples below may be modified appropriately as long as the modifications do not depart from the spirit of the present invention. Therefore, the scope of the present invention should not be construed as being limited to Examples.

### EXAMPLE 1

### [Formation of Thermoplastic Resin Layer]

A coating liquid for a thermoplastic resin layer, having the following formulation, was applied onto a temporary support made of a polyethylene terephthalate film (width: 1,610 mm, thickness: 75 μm) by a slot die, and dried at 100° C. for 3 minutes to form a thermoplastic resin layer having a thickness of 5 μm. A melt viscosity of the formed thermoplastic resin layer at 110° C. was 1,000 Pa·s.

Coating liquid for thermoplastic resin layer

| | |
|---|---|
| Binder A shown below | 8.47 parts by mass |
| 1-Methoxy-2-propyl acetate | 3.47 parts by mass |
| Binder B shown below | 24.6 parts by mass |
| Plasticizer: 2,2-bis[4- | 5.40 parts by mass |
| (methacryloxypolyethoxy)phenyl]propane | |
| (manufactured by Shin-Nakamura Chemical Co., | |
| Ltd.) | |
| Surfactant 1: MEGAFACE F-780-F (manufactured | 0.83 parts by mass |
| by Dainippon Ink and Chemicals, Inc.) | |
| Methyl ethyl ketone | 42.6 parts by mass |
| Methanol | 13.5 parts by mass |

### <Binder A>

AROMATICS FM601 (manufactured by Mitsui Chemicals, Inc.; weight-average molecular weight=90,000, concentration of solid contents=21% by mass; methyl methacrylate/2-ethylhexyl acrylate/benzyl methacrylate/methacrylic acid copolymer (molar ratio=55/11.7/4.5/28.2): 21 parts by mass, methyl ethyl ketone: 26 parts by mass, 1-methoxy-2-propyl acetate: 13 parts by mass, methanol: 40 parts by mass)

### <Binder B>

AROSET 7055 (manufactured by Nippon Shokubai Co., Ltd.; weight-average molecular weight=8,000, concentration of solid contents=41% by mass; styrene/acrylic acid copolymer (molar ratio 63/37): 41 parts by mass, methyl ethyl ketone: 50 parts by mass, 1-methoxy-2-propyl acetate: 9 parts by mass)

### [Formation of Alignment Layer]

A coating liquid for an alignment layer, having the following formulation, was applied onto the formed thermoplastic resin layer by a slot die, and dried at 100° C. for 1 minute to form an alignment layer having a thickness of 0.5 μm.

Coating liquid for alignment layer

| | | |
|---|---|---|
| Polyvinyl alcohol: PVA 205 (saponification | 2.1 | parts by mass |
| degree = 88%; manufactured by Kuraray Co., Ltd.) | | |
| Methanol | 44 | parts by mass |
| Distilled water | 53 | parts by mass |

### [Formation of Electro-Optical Layer (EO Layer)]

The laminate formed up to the alignment layer was cut out into 10 cm×10 cm, and the alignment layer of the cut-out sample spin-coated with an EO layer coating liquid having the following formulation at 400 rpm, and dried at 130° C. for 30 seconds to form an EO layer having a thickness of 1.8 μm.

A melt viscosity of the formed EO layer at 110° C. was 15,000 Pa·s.

In addition, a content of an organic coloring agent A contained in the formed EO layer was 9.8% by mass, and an alignment degree thereof was 0.60.

In addition, an alignment degree of a liquid crystal compound A contained in the formed EO layer was 0.80.

EO layer coating liquid

| | |
|---|---|
| Organic coloring agent A shown below | 0.050 g |
| Liquid crystal compound A shown below | 0.450 g |
| Alignment agent A shown below | 0.012 g |
| Chloroform | 4.490 g |

Organic coloring agent A (second-order molecular susceptibility: 1806×10⁻³⁰ esu)

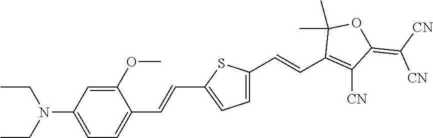 [SMILES: CCN(CC)c1ccc(/C=C/c2ccc(/C=C/C3=C(C#N)C(=C(C#N)C#N)OC3(C)C)s2)c(OC)c1]

Liquid crystal compound A (weight-average molecular weight: 12,000; numerical values in the following formula represent % by mass of each repeating unit)

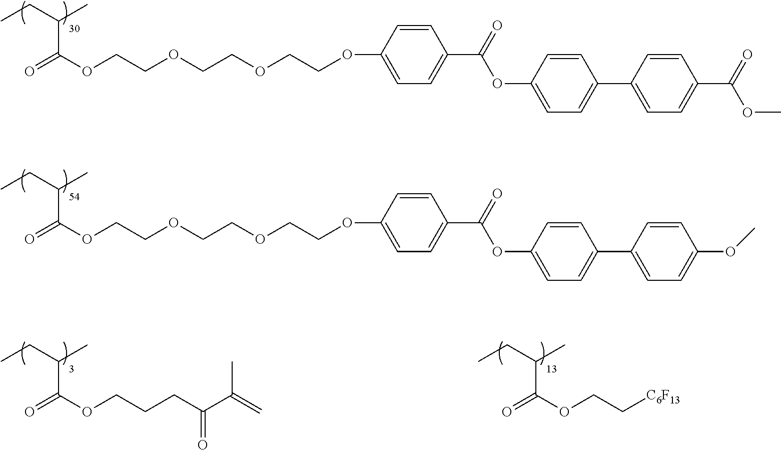

Alignment agent A (weight-average molecular weight: 25,000; numerical values in the following formula represent % by mass of each repeating unit)

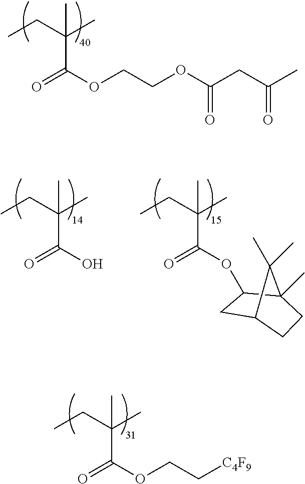

### [Formation of Protective Layer]

A protective layer made of polypropylene (thickness: 12 μm, surface roughness: 15 nm) was pressure-bonded and attached to the formed EO layer to produce a transfer film (layer configuration: temporary support/thermoplastic resin layer/alignment layer/EO layer/protective layer).

### [Production of Member for Optical Waveguide]

The protective layer of the produced transfer film was peeled off, and the exposed EO layer was bonded onto indium tin oxide (ITO) on a glass substrate on which ITO was sputtered, using a laminator (manufactured by Hitachi Industry & Control Solutions, Ltd. (LamicII type)) under pressurization and heating conditions of a linear pressure of 100 N/cm and a temperature of 110° C., at a transportation speed of 1 m/min.

Thereafter, the temporary support made of a polyethylene terephthalate film and the thermoplastic resin layer were peeled off to be removed.

Next, the obtained laminate (glass substrate/ITO/EO layer/alignment layer) was placed on a hot plate, and treated by corona poling.

Specifically, the EO layer was held at 50° C. for 10 minutes in a state in which a charging voltage of 6 kV was applied to the EO layer at an interval of 10 mm, the EO layer was air-cooled while applying the charging voltage from this state, and cooled to 23° C. over 10 minutes, and then the charging voltage was removed. Thereafter, the alignment layer was removed by a water washing treatment to obtain a thin film (layer configuration: glass substrate/ITO/EO layer) in which the organic coloring agent was aligned in the thickness direction.

### Examples 2 to 13

A transfer film and a thin film were produced by the same method as in Example 1, except that the thickness of the temporary support, the melt viscosity of the thermoplastic resin layer, the type or the formulation amount of the organic coloring agent, the type or the formulation amount of the liquid crystal compound, the formulation amount of the alignment agent, or the type of the solvent was changed to those shown in Table 1.

### [Evaluation]

### [Variation in Thickness]

The produced thin film was evaluated for variation in thickness of the EO layer by the following method and standard. The results are shown in Table 1. In Table 1, evaluation results of a thin film produced by directly applying the EO layer coating liquid used in each of Examples onto the glass substrate on which ITO was sputtered are also shown.

### <Measurement Method>

The thickness was measured using a surface roughness meter P-10 (manufactured by TENCOR).

### <Standard>

Heights of 100 film surfaces of the obtained thin film (11 cm×11 cm) at an interval of 1 cm were measured with a three-dimensional surface structure analysis microscope (manufacturer: ZYGO Corporation, model: New View 5022), and the variation in the maximum value or the minimum value of the spacer was evaluated as a percentage. C or higher is a practical level.
A: variation in thickness of the EO layer was less than +2.0%, which was extremely favorable.
B: variation in thickness of the EO layer was +2.0% or more and less than 3.0%, which was favorable.
C: variation in thickness of the EO layer was +3.0% or more and less than 5.0%, which was normal.
D: variation in thickness of the EO layer was +5.0% or more, which was unfavorable.

### [Transferability]

### <Minute Bubbles>

The produced transfer film was laminated onto a 0.7 mm-thick Si substrate (having a protrusion line of Si of 0.4 μm×2000 μm on the Si substrate) at a laminating speed of 1 m/min while changing a laminating roll temperature, and transferability was evaluated by a temperature at which the transfer could be performed without defects. The presence or absence of air bubbles was observed with an optical microscope at 1000× magnification.
A: temperature at which the transfer could be performed without air bubbles was lower than 120° C.
B: temperature at which the transfer could be performed without air bubbles was 120° C. or higher and lower than 130° C.
C: temperature at which the transfer could be performed without air bubbles was 130° C. or higher and lower than 140° C.
D: temperature at which the transfer could be performed without air bubbles was 140° C. or higher and lower than 150° C.
E: temperature at which the transfer could be performed without air bubbles was 150° C. or higher.

### <Large Bubbles>

The produced transfer film was laminated onto a 0.7 mm-thick Si substrate (having a protrusion line of Si of 0.4 μm×2000 μm on the Si substrate) at a laminating speed of 1 m/min while changing a laminating roll temperature, and transferability was evaluated by a temperature at which the transfer could be performed without defects of air bubbles. The presence or absence of air bubbles was observed with an optical microscope at 50× magnification.
A: temperature at which the transfer could be performed without air bubbles was lower than 120° C.
B: temperature at which the transfer could be performed without air bubbles was 120° C. or higher and lower than 130° C.
C: temperature at which the transfer could be performed without air bubbles was 130° C. or higher and lower than 140° C.
D: temperature at which the transfer could be performed without air bubbles was 140° C. or higher and lower than 150° C.
E: temperature at which the transfer could be performed without air bubbles was 150° C. or higher.

### [Electro-Optical Constant]

For the produced thin film, an electro-optical constant (hereinafter, also abbreviated as “r value”) was obtained as an indicator of a nonlinear optical performance. The r value was calculated by measuring dependence of a change in refractive index at a wavelength of 1,309 nm on an applied voltage (measured at 0 V, 10 V, and 20 V) using a prism coupler device (MODEL 2010/M manufactured by METRICON CORPORATION) and a coated prism (P-200C, a prism coated with nickel on a prism surface) for the thin film obtained by the electric field poling treatment. The results are shown in Table 1.

The r value was calculated by the following expression (2). In Expression (2), δn/δV represents a slope of the dependence of the change in refractive index on the applied voltage, d represents a thickness (pm) of the thin film, and nTM represents a refractive index of the thin film not applied with a voltage in a case where a TM wave is incident.

In addition, In Table 1, evaluation results of a thin film produced by directly applying the EO layer coating liquid used in each of Examples onto the glass substrate on which ITO was sputtered are also shown.

$$r = \{ ( δ n / δ V ) \times 2 \times d ] \} / ( {n}_{TM}^{3} ) \qquad Expression ( 2 )$$

TABLE 1

| | | | | EO layer | | | | | | | |
|---|---|---|---|---|---|---|---|---|---|---|---|
| | | Thermoplastic | | | | | | % by mass with respect | | | |
| | Temporary | resin layer | | | | | | to solid contents | | | |
| | support | | Melt | Organic | Liquid | | | Organic | Liquid | | Melt |
| | Thickness | Thickness | viscosity | coloring | crystal | Alignment | | coloring | crystal | Alignment | viscosity |
| | (μm) | (μm) | (Pa · s) | agent | compound | agent | Solvent | agent | compound | agent | (Pa · s) |
| Example | 75 | 5 | 1000 | Coloring | A | A | Chloroform | 9.8 | 87.9 | 2.3 | 15000 |
| 1 | | | | agent A | | | | | | | |
| Example | 75 | 5 | 1000 | Coloring | A | A | NMP | 9.8 | 87.9 | 2.3 | 15000 |
| 2 | | | | agent A | | | | | | | |
| Example | 75 | 5 | 1000 | Coloring | B | A | MEK | 9.8 | 87.9 | 2.3 | 10000 |
| 3 | | | | agent A | | | | | | | |
| Example | 75 | 5 | 1000 | Coloring | C | A | Toluene | 9.8 | 87.9 | 2.3 | 5000 |
| 4 | | | | agent A | | | | | | | |
| Example | 75 | 5 | 1000 | Coloring | A | A | Chloroform | 9.8 | 87.9 | 2.3 | 20000 |
| 5 | | | | agent B | | | | | | | |
| Example | 75 | 5 | 1000 | Coloring | A | A | Chloroform | 9.8 | 87.9 | 2.3 | 12000 |
| 6 | | | | agent C | | | | | | | |
| Example | 75 | 5 | 1000 | Coloring | A | A | Chloroform | 9.8 | 87.9 | 2.3 | 10000 |
| 7 | | | | agent D | | | | | | | |
| Example | 16 | 5 | 1000 | Coloring | A | A | Chloroform | 9.8 | 87.9 | 2.3 | 15000 |
| 8 | | | | agent A | | | | | | | |
| Example | 75 | 5 | 3000 | Coloring | A | A | Chloroform | 9.8 | 87.9 | 2.3 | 15000 |
| 9 | | | | agent A | | | | | | | |
| Example | 75 | 5 | 1000 | Coloring | A | A | Chloroform | 4.9 | 92.8 | 2.3 | 12000 |
| 10 | | | | agent A | | | | | | | |
| Example | 75 | 5 | 1000 | Coloring | A | A | Chloroform | 19.6 | 78.1 | 2.3 | 18000 |
| 11 | | | | agent A | | | | | | | |
| Example | 75 | 5 | 1000 | Coloring | A | A | Chloroform | 9.8 | 95.7 | 4.6 | 15000 |
| 12 | | | | agent A | | | | | | | |
| Example | 75 | None | None | Coloring | A | A | Chloroform | 9.8 | 87.9 | 2.3 | 15000 |
| 13 | | | | agent A | | | | | | | |

| | Various physical property values | | | | | | | | | |
|---|---|---|---|---|---|---|---|---|---|---|
| | Second-order | | | | | | | | | |
| | molecular | | | Evaluation | | | | | | |
| | susceptibility | Alignment degree | | Variation in | | | | | Electro-optical | |
| | βo of organic | Organic | Liquid | thickness of EO layer | | | Transferability | | constant | |
| | coloring agent | coloring | crystal | Thickness | | | Minute | Large | (r value) | |
| | (×10⁻³⁰ esu) | agent | compound | (μm) | Transfer | Coating | bubbles | bubbles | Transfer | Coating |
| Example | 1806 | 0.6 | 0.8 | 1.8 | A | D | A | B | 40 | White |
| 1 | | | | | | | | | | turbidness, |
| | | | | | | | | | | not |
| | | | | | | | | | | measured |
| Example | 1806 | 0.6 | 0.8 | 1.8 | A | D | A | B | 40 | White |
| 2 | | | | | | | | | | turbidness, |
| | | | | | | | | | | not |
| | | | | | | | | | | measured |
| Example | 1806 | 0.6 | 0.8 | 1.8 | A | B | A | B | 38 | 34 |
| 3 | | | | | | | | | | |
| Example | 1806 | 0.6 | 0.8 | 1.8 | A | C | A | B | 36 | 32 |
| 4 | | | | | | | | | | |
| Example | 2851 | 0.4 | 0.8 | 1.8 | A | D | A | B | 40 | White |
| 5 | | | | | | | | | | turbidness, |
| | | | | | | | | | | not |
| | | | | | | | | | | measured |
| Example | 349 | 0.7 | 0.8 | 1.8 | A | D | A | B | 10 | White |
| 6 | | | | | | | | | | turbidness, |
| | | | | | | | | | | not |
| | | | | | | | | | | measured |
| Example | 262 | 0.8 | 0.8 | 1.8 | A | D | A | B | 8 | White |
| 7 | | | | | | | | | | turbidness, |
| | | | | | | | | | | not |
| | | | | | | | | | | measured |
| Example | 1806 | 0.6 | 0.8 | 1.8 | A | D | A | A | 40 | White |
| 8 | | | | | | | | | | turbidness, |
| | | | | | | | | | | not |
| | | | | | | | | | | measured |
| Example | 1806 | 0.6 | 0.8 | 1.8 | B | D | B | C | 40 | White |
| 9 | | | | | | | | | | turbidness, |
| | | | | | | | | | | not |
| | | | | | | | | | | measured |
| Example | 1806 | 0.7 | 0.8 | 1.8 | A | D | A | B | 25 | White |
| 10 | | | | | | | | | | turbidness, |
| | | | | | | | | | | not |
| | | | | | | | | | | measured |
| Example | 1806 | 0.4 | 0.8 | 1.8 | A | D | A | B | 50 | White |
| 11 | | | | | | | | | | turbidness, |
| | | | | | | | | | | not |
| | | | | | | | | | | measured |
| Example | 1806 | 0.55 | 0.7 | 1.8 | A | D | A | B | 35 | White |
| 12 | | | | | | | | | | turbidness, |
| | | | | | | | | | | not |
| | | | | | | | | | | measured |
| Example | 1806 | 0.6 | 0.8 | 1.8 | C | A | 0 | E | 40 | White |
| 13 | | | | | | | | | | turbidness, |
| | | | | | | | | | | not |
| | | | | | | | | | | measured |

Structures of organic coloring agents B to D and liquid crystal compounds B and C in Table 1 are shown below.

Organic coloring agent B (second-order molecular susceptibility: 2851×10⁻³⁰ esu)

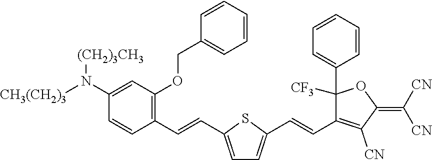

Organic coloring agent C (second-order molecular susceptibility: 349×10⁻³⁰ esu)

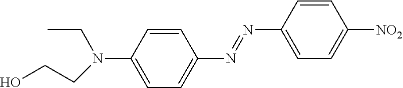 [SMILES: CCN(CCO)c1ccc(/N=N/c2ccc([N+](=O)[O-])cc2)cc1]

Organic coloring agent D (second-order molecular susceptibility: 262×10⁻³⁰ esu)

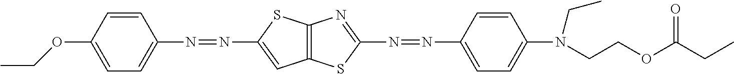 [SMILES: CCOc1ccc(N=Nc2cc3sc(N=Nc4ccc(N(CC)CCOC(=O)CC)cc4)nc3s2)cc1]

Liquid crystal compound B (weight-average molecular weight: 30,000; numerical values in the following formula represent % by mass)

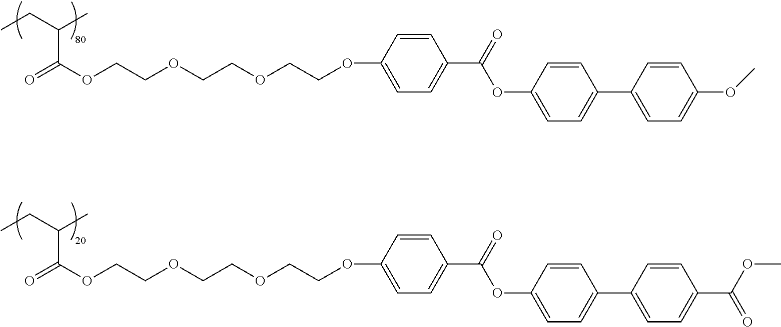

Liquid crystal compound C

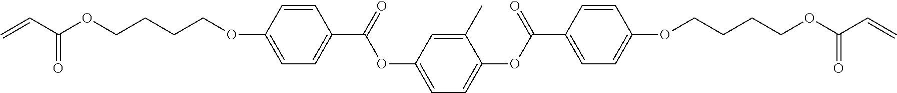 [SMILES: C=CC(=O)OCCCCOc1ccc(C(=O)Oc2ccc(OC(=O)c3ccc(OCCCCOC(=O)C=C)cc3)c(C)c2)cc1]

From the results shown in Table 1, it was found that, in a case where the thin film (layer configuration: glass substrate/ITO/EO layer) was produced using the transfer film (layer configuration: temporary support/thermoplastic resin layer/alignment layer/EO layer/protective layer), the variation in thickness was suppressed and a high electro-optical constant was exhibited as compared with the thin film produced by coating (Examples 1 to 13).

### EXPLANATION OF REFERENCES

10, 20: transfer film
11: temporary support
12: alignment layer
13: electro-optical layer
14: thermoplastic resin layer
15: protective layer

What is claimed is:

1. A transfer film for producing a member for an optical waveguide, the transfer film comprising, in the following order:
a temporary support;
an alignment layer; and
an electro-optical layer containing an organic coloring agent.

2. The transfer film according to claim 1, further comprising:
a thermoplastic resin layer between the temporary support and the alignment layer.

3. The transfer film according to claim 2,
wherein a melt viscosity of the thermoplastic resin layer at 110° C. is 200 to 3,000 Pa·s.

4. The transfer film according to claim 1,
wherein a melt viscosity of the electro-optical layer at 110° C. is 350 to 180,000 Pa·s.

5. The transfer film according to claim 1,
wherein the alignment layer is a rubbing-treated alignment layer or a photo-alignment layer.

6. The transfer film according to claim 1,
wherein the electro-optical layer contains an organic coloring agent having a second-order molecular susceptibility of 300×10⁻³⁰ esu or more.

7. The transfer film according to claim 1,
wherein an alignment degree of the organic coloring agent contained in the electro-optical layer is 0.25 to 0.95.

8. The transfer film according to claim 1,
wherein the electro-optical layer further contains a liquid crystal compound.

9. The transfer film according to claim 8,
wherein an alignment degree of the liquid crystal compound contained in the electro-optical layer is 0.50 to 0.95.

10. The transfer film according to claim 1, further comprising:
a protective layer on a side of the electro-optical layer opposite to the alignment layer.

11. The transfer film according to claim 10,
wherein a surface roughness R^{a} of the protective layer on a side of the electro-optical layer is 50 nm or less.

12. The transfer film according to claim 10,
wherein the protective layer is a polypropylene film.

13. The transfer film according to claim 1,
wherein the temporary support is a polymer film containing at least one selected from the group consisting of polypropylene, polyethylene, polyethylene terephthalate, polyethylene naphthalate, and triacetyl cellulose.

14. The transfer film according to claim 13,
wherein a thickness of the temporary support is 5 to 200 μm.

15. The transfer film according to claim 2,
wherein a thickness of the thermoplastic resin layer is 2 to 20 μm.

16. A manufacturing method of an optical waveguide, comprising:
a step of adhering the electro-optical layer included in the transfer film according to claim 1 to an adherend to form an optical waveguide.

17. The transfer film according to claim 2,
wherein a melt viscosity of the electro-optical layer at 110° C. is 350 to 180,000 Pa·s.

18. The transfer film according to claim 2,
wherein the alignment layer is a rubbing-treated alignment layer or a photo-alignment layer.

19. The transfer film according to claim 2,
wherein the electro-optical layer contains an organic coloring agent having a second-order molecular susceptibility of 300×10⁻³⁰ esu or more.

20. The transfer film according to claim 2,
wherein an alignment degree of the organic coloring agent contained in the electro-optical layer is 0.25 to 0.95.
